(19) United States
(12) Patent Application Publication
(10) Pub. No.: US 2010/0022924 A1
(43) Pub. Date: Jan. 28, 2010

(54) VIBRATORY PLATFORM

(75) Inventor: Tim Stieler, Belle River (CA)

Correspondence Address: GIFFORD, KRASS, SPRINKLE,ANDERSON & CITKOWSKI, P.C, PO BOX 7021, TROY, MI, 48007-7021, US

(73) Assignee: Nadamisa Inc., Windsor (CA)

(21) Appl. No.: 12/177,216

(22) Filed: Jul. 22, 2008

(51) Int. Cl. A61H 1/00

(52) U.S. Cl. 601/52

(57) ABSTRACT

A vibratory table having a base and a platform movably supported above the base. The vibratory table includes a roller support secured to the platform and a first and a second driveshaft rotatably mounted to the roller support so that the shafts are spaced apart and parallel to each other. A first gear is secured to the first shaft which meshes with a second gear secured to the second shaft so that the shafts rotate in synchronism with each other and in opposite directions. A roller is disposed over each shaft while a shift mechanism is contained within each roller. Each shift mechanism is operable to move the roller in a radial direction to a position offset from the axis of the roller to create an unbalanced load for the rollers. A motor rotatably drives at least one of the shafts.

### BACKGROUND OF THE INVENTION

I. Field of the Invention

The present invention relates generally to physical therapy devices and, more particularly, to a physical therapy vibratory table.

II. Description of Material Art

It is well known that during extended periods of inactivity, muscle atrophies and loses its muscle tone. As a result, after extended periods of inactivity, such muscles become very weak and require physical therapy in order to regain the muscle tone and muscle strength.

For example, it is known that astronauts who spend extended periods of time in outer space lose muscle tone through their body due to loss of gravity while in space. In order to prevent, or at least lessen, muscle atrophy, a physical therapy vibratory platform has been previously developed. This previously known physical therapy vibratory table includes a base with a platform supported above the base by rubber bushings. A vibratory motor is attached to the platform so that, upon activation of the motor, the motor vibrates the platform at one or more vibratory speeds.

The vibratory assembly for creating the vibration of the platform for these previously known physical therapy devices, however, has been rudimentary in construction. Typically, the vibratory assembly consisted of little more than a motor with an offset weight attached to the motor shaft. Consequently, rotation of the offset weight by the motor creates an unbalanced load which results in the transmission of vibration to the platform. Some of these previously known devices include two or even more of the motors.

The physically known vibratory tables for physical therapy, however, all suffer from two primary disadvantages. First, the vibration created by the vibratory assembly and imparted to the platform included movement of the platform in not only a vertical direction, but also a horizontal direction. In practice, the vertical direction of vibration for the platform produces the desired therapeutic result for the rehabilitation patient. Conversely, lateral or horizontal vibration of the platform may induce undesirable stress in the joints of the therapy patient. Such stress may damage or injure the joints after prolonged use.

A still further disadvantage of the previously known vibratory platforms for therapeutic use is that the amplitude of the vertical vibration was fixed and could not be altered to vary the vertical travel of the vibratory platform between a lower and upper limit. For therapeutic uses, however, it would be highly desirable to vary the vertical amplitude of the vibration to not only accommodate different patients with different physical characteristics, but also to provide the correct amount of vertical amplitude for the vibration for the physical treatment or therapy of a particular patient.

### SUMMARY OF THE PRESENT INVENTION

The present invention provides a vibratory table for physical therapy which overcomes the above-mentioned disadvantages of the previously known devices.

In brief, the vibratory table of the present invention comprises a base and a platform movably supported above the base. Preferably, pneumatically filled bladders support the platform above the base, although other support means may be used without deviation from the spirit or scope of the invention.

A vibratory assembly is also provided to vibrate the platform relative to the base substantially only in a vertical direction. This vibratory assembly includes a roller support that is secured to the platform by any conventional means. A first and second driveshaft are then rotatably mounted to the roller support so that the first and second shafts are spaced apart and parallel to each other.

A mechanical coupler arrangement then connects the first shaft to the second shaft so that the first and second shafts rotate in synchronism with each other and in opposite rotational directions. Preferably, meshing gears form the mechanical coupler arrangement.

A first roller is disposed over the first shaft and, similarly, a second roller is disposed over the second shaft. Each roller is fixed against rotation with respect to its associated shaft but is movable along a predefined radial direction with respect to its associated shaft. Movement of the roller along the predefined radial direction offsets the axis of the roller relative to the shaft axis along that predefined radial direction.

A bladder is disposed in each roller so that the bladder is positioned in between each roller and its associated shaft. Inflation or deflation of the bladders thus displaces the rollers along the predefined radial direction in an amount dependent upon the inflation of the bladder. Preferably, the bladder is pneumatically inflated.

A motor is rotatably drivingly connected to at least one of the shafts. Thus, upon activation of the motor, the rotation of one shaft rotatably drives the other shaft in the opposite rotational direction and so that the rotational position of the shafts are in synchronism with each other.

Inflation of the bladder will thus move the axes of the rollers away from the axes of the shafts and create an unbalanced load. This unbalanced load in turn results in vibration which is transmitted to the vibratory platform.

In practice, the synchronized rotation of the rollers in the opposite rotational directions by the mechanical coupler arrangement is sufficient to eliminate horizontal movement of the vibratory platform since the horizontal force imparted by each roller on the platform is offset by the other roller. Similarly, the vertical amplitude of the vibratory platform may be varied by increasing or decreasing the inflation of the bladders as desired. Increased inflation resulting in a greater offset between the axis of the roller and the axis of its associated axle provides a larger unbalanced load and thus a greater amplitude of vibration for the vibratory platform and vice versa.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a side view illustrating a preferred embodiment of the present invention;

FIG. 2 is an elevational view illustrating the vibratory assembly of the present invention;

FIG. 3 is an exploded view illustrating the vibratory assembly;

FIG. 4 is a top view of the vibratory assembly;

FIG. 5 is a sectional view taken substantially along line 5-5 in FIG. 4;

FIG. 6 is a cross-sectional view of the vibratory assembly and illustrating the rollers in a balanced position; and

FIG. 7 is a view similar to FIG. 6, but illustrating the rollers in an unbalanced position.

### DETAILED DESCRIPTION OF A PREFERRED EMBODIMENT OF THE PRESENT INVENTION

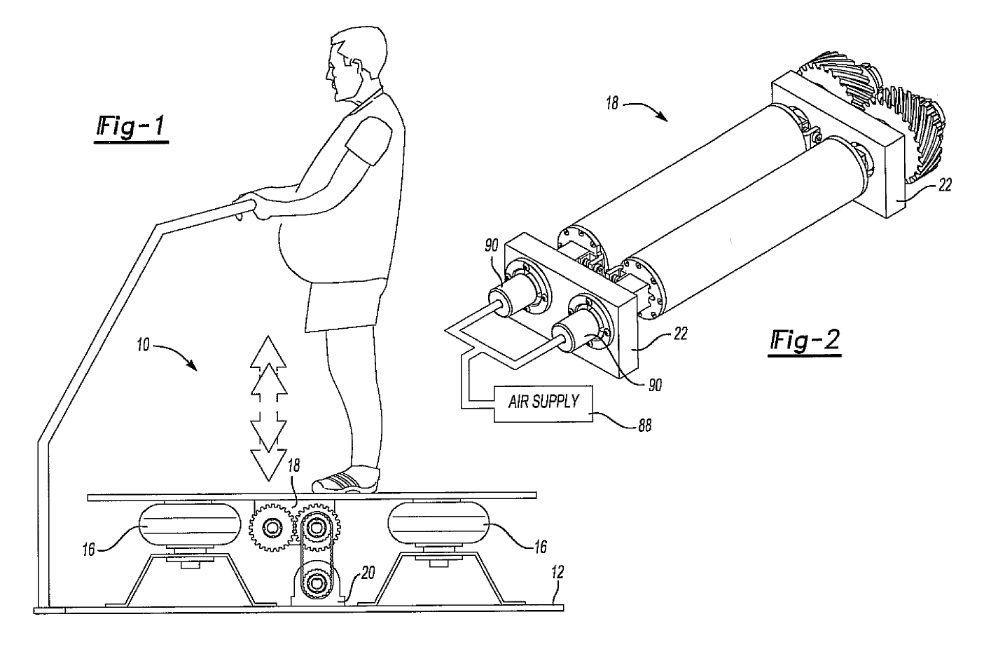

With reference first to FIG. 1, a vibratory table 10 in accordance with the present invention is illustrated. The vibratory table 10 is of the type used for physical therapy. Such physical therapy may include treatment for atrophied or otherwise weakened muscles.

The vibratory table includes a base 12 which is supported on a ground surface. A vibratory platform 14 is movably supported above the base 12 by any conventional means, such as pneumatic bladders 16.

A vibratory assembly 18 is mounted to a bottom of the support platform 14. The vibratory assembly 18 is rotatably driven by a motor 20. The motor 20 is illustrated in FIG. 1 as mounted to the base 12 although the motor 20 may alternatively be mounted directly to the platform 14.

With reference now to FIGS. 2-5, the vibratory assembly 18 is there shown in greater detail. The vibratory assembly 18 includes a pair of spaced apart roller supports 22 which are constructed of any rigid material, such as metal. These roller supports 22, furthermore, are attached to the bottom of the vibratory platform 14 in any conventional fashion, such as by bolts.

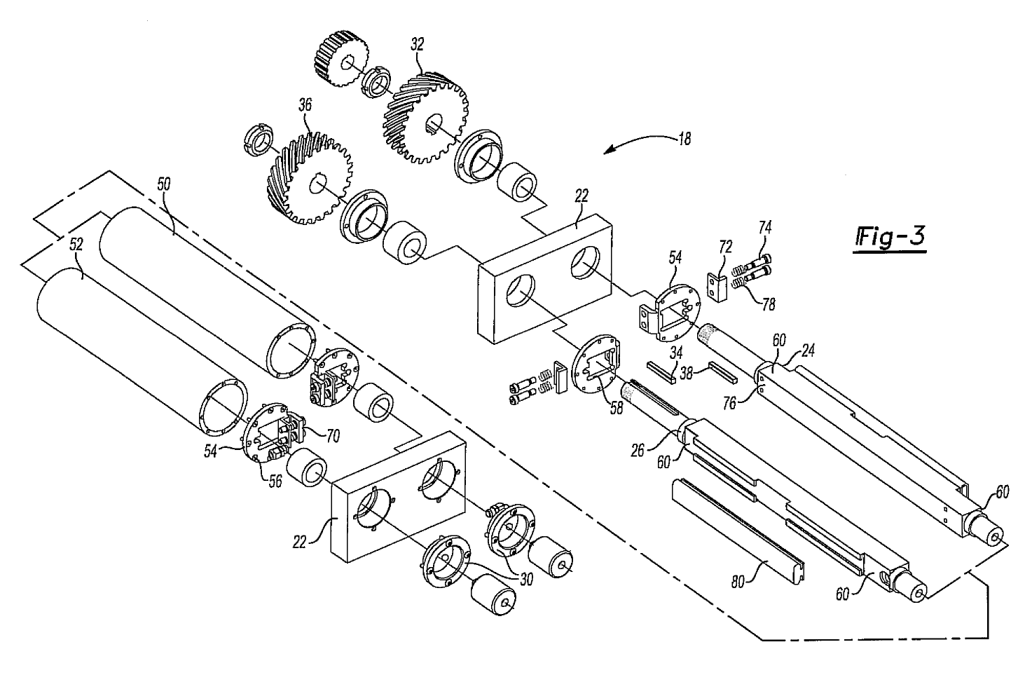

As best shown in FIGS. 3 and 5, a first shaft 24 and a second shaft 26 are rotatably mounted to the roller supports 22 so that the rotational axes of the shafts 24 and 26 are spaced apart and parallel to each other. The shafts 24 and 26 are freely rotatably mounted to the roller supports 22 by any conventional bearing assembly 28 (FIG. 5), such as a roller bearing assembly and bearing retainers 30.

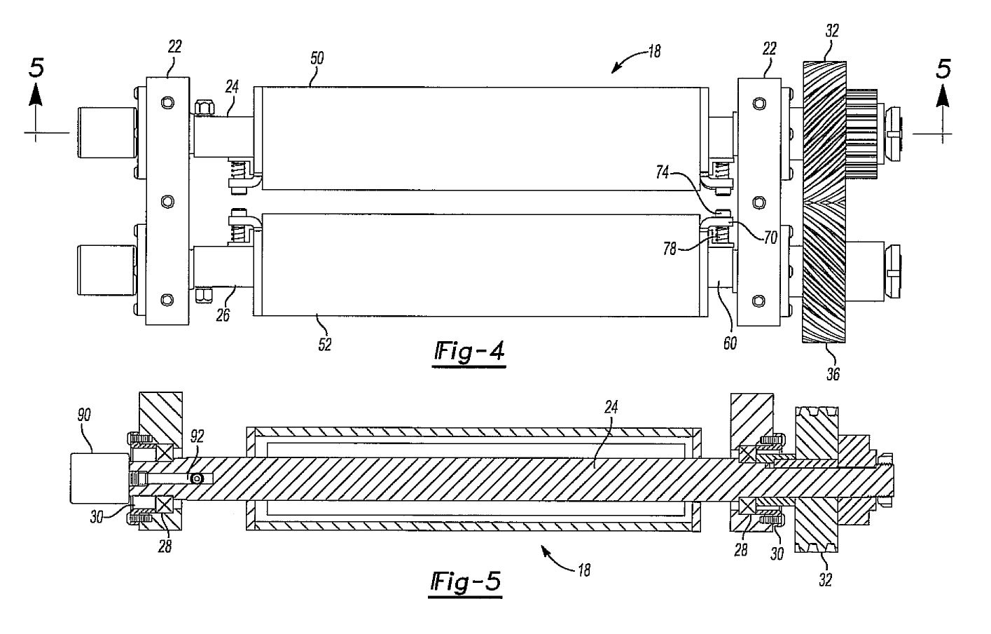

As best shown in FIGS. 3 and 4, a first gear 32 is secured to one end of the first shaft 24 by a key 34 (FIG. 3). Similarly, a second gear 36 is secured to one end of the second shaft 26 by a second key 38 so that the rotational position of each gear 32 or 36 relative to its associated shaft 24 or 26 is fixed.

The gears 32 and 36 are dimensioned so that the gears 32 and 36 are in mesh with each other after assembly (FIG. 4). Consequently, the gears 32 and 36 form a mechanical coupler arrangement which both synchronizes the rotation of the shafts 24 and 26 and also rotatably drives the shafts 24 and 26 in opposite rotational directions.

Although the mechanical coupler arrangement is illustrated in the drawing as the two gears 32 and 36, it will be understood, of course, that other means may alternatively be utilized to ensure that the shafts 24 and 26 rotate in the opposite rotational direction from each other and in synchronism with each other. For example, an endless belt in a figure eight configuration disposed between the shafts 24 and 26 will also achieve such synchronism of rotation in the opposite direction of the shafts 24 and 26.

With reference now particularly to FIGS. 3-5, a first roller 50 is disposed around, and over the first shaft 24 in between the roller supports 22 while, similarly, a second roller 52 is disposed around, and over the second shaft 26 also in between the roller supports 22. Both rollers 50 and 52 are elongated and generally tubular in shape between their ends.

As best shown in FIG. 3, an end cap 54 is secured to each end of the rollers 50 and 52 by any conventional means, such as bolts 56. Consequently, the rotational position of each end cap 56 is fixed relative to its associated roller 50 or 52.

Each end cap 56, furthermore, includes a rectangular opening 58. This rectangular opening 58 is disposed over a square portion 60 of the shafts 24 or 26 which are complementary in shape. Consequently, with the end caps 54 disposed over their respective shafts 24 and 26 and secured to their respective rollers 50 and 52, the rotational position of the rollers 50 and 52 is fixed relative to their associated shafts 24 and 26, respectively.

The rectangular opening 58 in each end cap 54 is illustrated in the drawing as rectangular in shape having two short sides and long sides while the end portions 60 of the shafts 24 and 26 are illustrated as being square in shape with a side length substantially the same as the short side of the rectangular opening 58. Consequently, with the portion 24 positioned through the opening 58 in its associated end cap 54, some radial movement of the roller 50 or 52 in a predefined radial direction parallel to the long sides of the opening 58 can occur.

Referring now to FIGS. 3 and 4, each roller end cap 54 includes a tab 70 which protrudes outwardly from the end cap 54 and overlies a portion of its associated shaft 24 or 26. At least one, and preferably two, holes are provided through the tabs 70.

An L-shaped bracket 72 is positioned against the square portion 60 of the shaft 24 or 26 and so that one side of the bracket 72 is slidably positioned along the end cap 54. One or more screws 74 then slidably extend through the openings in the tab 70, registering openings in the bracket 72 and threadably engage threaded holes 76 formed in the shaft 24 and 26. A compression spring is also disposed between the tab 70 and the bracket 72 as best shown in FIG. 4.

The tab 70, bracket 72 and spring 78 thus serve two purposes. First, since one bracket 72 is positioned at each end of the roller 50 and 52, the rollers 50 and 52 are trapped against axial movement with respect to their associated shafts 24 and 26. Secondly, the bolts 74 form an alignment pin which prevents rotational movement of the end caps 54, and thus their attached rollers 50 and 52, relative to their associated shafts 24 and 26. Consequently, both the rotational position and axial position of each roller 50 and 52 is fixed relative to its associated shaft 24 and 26.

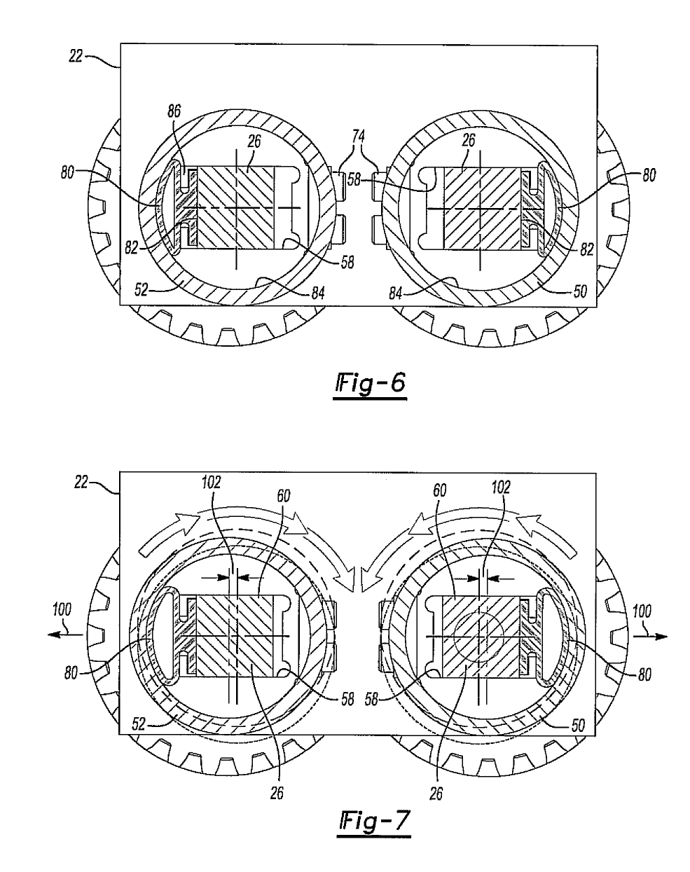

With reference now to FIGS. 3 and 6, an elongated pneumatically inflatable bladder 80 is associated with each roller so that the bladder 80 is positioned in between a flat 82 on the shaft 24 or 26 and an inner surface 84 of its associated roller 50 or 52. Any conventional means, such as a flange 86 on the shaft 24 and 26, may be employed to secure the bladder 80 to its associated shaft 24 or 26.

As best shown in FIG. 2, a pneumatic or pressurized air supply 88 is fluidly connected to the bladders 80 using conventional pneumatic fluid fittings 90. These fluid fittings 90 fluidly communicate with fluid passageways 92 (FIG. 5) and the shafts 24 and 26 which, in turn, are fluidly connected to the bladder 80 associated with each shaft 24 and 26.

With reference now to FIGS. 6 and 7, in FIG. 6 the bladders 80 are deflated. In doing so, the bladders 80, which are positioned on the side of the shafts 24 and 26 opposite from the compression springs 78, allow the compression springs 78 to move the rollers 50 and 52 to a position in which the axis of each roller 50 and 52 is aligned with its associated shaft 24 and 26. Upon deflation of the bladders 80, the alignment pins 74, also limit the direction and magnitude of radial travel of the rollers 50 and 52 so that each roller 50 and 52 is coaxial with its associated shaft 24 and 26. Consequently, at this time, the rollers 50 and 52 are balanced relative to the shafts 24 and 26 so that rotation of the shafts 24 and 26 will not result in any appreciable vibration.

With reference now particularly to FIG. 7, the bladders 80 are there shown inflated with each bladder 80 inflated to the same degree, i.e. by the same pneumatic pressure. The inflation of each bladder 80 thus radially shifts its associated roller 50 or 52 along a predetermined radial direction 100 against the force of the compressing springs 78 thus creating an offset 102 between the axis of the shafts 24 and 26. This offset 102, furthermore, is substantially the same for each roller 50 and 52.

The inflation of each bladder 80 thus radially shifts its associated roller 50 and 52 against the force of the compression springs 78 (FIG. 4) which also causes the square portion 60 of each shaft 24 and 26 to slide along the rectangular opening 58 in the roller end caps 54. Thus, the cooperation between the square portion 60 of each shaft 24 and 26 and the rectangular opening 58 in the roller end cap 54 allows the rollers 50 and 52 to axially move only in the predefined radial direction 100.

The bladder 80 thus forms a shift mechanism for shifting the rollers 50 and 52 relative to their respective shafts 24 and 26. Other means such as a mechanical shifter, may alternatively be used without deviation from the spirit or scope of the invention.

The movement of the rollers 50 and 52 to the position shown in FIG. 7 in which the axes of the rollers 50 and 52 is offset from the axes of their respective shafts 24 and 26 causes an unbalanced load during rotation of the shafts 24 and 26. Consequently, upon rotation of one shaft 24 or 26, the unbalanced load provided by the offset rollers 50 and 52 creates a vibration which is transmitted to the vibratory platform 14. The amplitude of this vibration, furthermore, is proportional with the magnitude of the offset 102, and thus the magnitude of the unbalanced load, between the axes of the rollers 50 and 52 and the axes of their respective shafts 24 and 26.

In practice, the opposite and synchronous rotation of the rollers 50 and 52 effectively cancel out vibration in the horizontal direction since each roller 50 and 52 presents an equal but opposite horizontal force on the roller supports 22 and thus on the vibratory platform 14. Conversely, the rotation of the rollers 50 and 52 when unbalanced as shown in FIG. 7 impart a vertical force or vibration to the platform 14 and the amplitude of this vibration may be varied by simply changing the degree of inflation of the bladders 80. Such variable inflation of the bladders 80 may be achieved by simply varying the pressure from the air supply 88.

Although the rollers 50 and 52 are used as counterweights, it will be understood that any type of counterweight other than a roller may alternatively be used.

From the foregoing, it can be seen that the present invention provides a vibratory table for therapeutic use which creates vibratory movement only in a vertical direction and in an amplitude which may be easily varied by the user. Having described my invention, however, many modifications thereto will become apparent to those skilled in the art to which it pertains without deviation from the spirit of the invention as defined by the scope of the appended claims.

I claim:

1. A vibratory table for therapeutic use comprising:
a base,
a platform movably supported above said base,
a roller support secured to the platform,
a first and a second drive shaft rotatably mounted to said roller support so that said shafts are spaced apart and parallel to each other,
a mechanical coupler arrangement connecting said first shaft to said second shaft so that said first and second shafts rotate in synchronism with each other and in opposite rotational directions,
a first counterweight disposed over said first shaft and a second counterweight disposed over said second shaft, each counterweight being fixed against rotation with respect to its associated shaft but movable along a defined radial direction with respect to its associated shaft,
a shift mechanism contained in each roller, each shift mechanism having a portion disposed between its associated counterweight and shaft, each shift mechanism operable to radially shift its associated counterweight along said defined radial direction to a selected position so that an offset of the axis of each counterweight from an axis of its associated shaft is substantially the same for each counterweight, and
a motor rotatably drivingly connected to at least one of said shafts.

2. The invention as defined in claim 1 wherein said mechanical coupler arrangement comprises a first gear coaxially secured to said first shaft and a second gear coaxially secured to said second shaft, said first and second gears being in mesh with each other.

3. The invention as defined in claim 1 wherein said shift mechanism comprises an inflatable bladder.

4. The invention as defined in claim 3 wherein said bladder is pneumatically inflatable.

5. The invention as defined in claim 3 and comprising a spring associated with each roller, each said spring being biased to urge its associated counterweight toward a position coaxial with its associated shaft.

6. The invention as defined in claim 3 wherein each shaft includes an elongated and longitudinally extending flat, wherein each bladder is elongated and wherein each bladder is positioned against said flat of its associated shaft.

7. The invention as defined in claim 1 wherein said motor is mounted to said base and drivingly connected to said at least one shaft by a drive belt.

8. The invention as defined in claim 1 wherein said first counterweight comprises a first roller and said second counterweight comprises a second roller.

9. The invention as defined in claim 8 and comprising a first and a second tab, said first tab attached to one end of said first roller and said second tab attached to one end of said second roller, each tab having an opening, a first alignment pin extending through said opening in said first tab and threadably engaging a threaded hole in said first shaft, and a second alignment pin extending through said opening in said second tab and threadably engaging a threaded hole in said second shaft.

10. The invention as defined in claim 9 and comprising a compression spring disposed between each tab and its associated shaft.

11. The invention as defined in claim 8 wherein each shaft includes a square section adjacent each end and comprising an end cap secured to each end of each roller, said end caps each having a rectangular opening larger in one axis than the square section of said shafts, said square section of said shafts being positioned through said rectangular opening in said end caps so that said rollers are able to slide relative to their associated shaft along only said one axis.
